(19) United States
(12) Patent Application Publication
(10) Pub. No.: US 2015/0273331 A1
(43) Pub. Date: Oct. 1, 2015

(54) System, Method, and Apparatus for Critical Hits

(71) Applicant: Xaviant, LLC (a GA Limited Liability Company), Cumming, GA (US)

(72) Inventors: Michael Parker McMain, Cumming, GA (US); James Robert Weinhart, Alpharetta, GA (US)

(21) Appl. No.: 14/230,014

(22) Filed: Mar. 31, 2014

(51) Int. Cl. A63F 13/537

(52) U.S. Cl. CPC A63F 13/537

(57) ABSTRACT

A gaming system in which a player is presented with multiple targets and, upon firing a trigger, the gaming system determines an intended target from the multiple targets and acts upon the intended target. If a player invokes “critical hits,” the intended target is provided with dire consequences. If the player does not invoke “critical hits,” the intended target receives algorithmically determined consequences, for example, a probability of dire consequences, partial destruction, wounding, reduction in health, etc. Examples of dire consequences include, but are not limited to, annihilation of the intended target, killing (virtual) of the intended target, freezing (virtual) of the intended target, setting the intended target on fire (virtual), etc.

### FIELD

This invention relates to the field of targeting and more particularly to a system for assuring significant effect or dire consequences (e.g. annihilation) against a targeted object within a video game.

### BACKGROUND

Video games for home use were first introduced in the early 1970's, most notably was a game called “Pong” that was an early arcade game that simulated a table tennis game. Each player had a simple rotating control that moved that player's paddle vertically on a screen to intercept a moving ball and redirect the ball towards the other player's side. In 1975, a famous video game manufacturer released a home version of Pong which had similar controls, but the playing field was displayed on a television.

Throughout the 1970's and 1980's the gaming industry saw substantial and profitable growth in game consoles. The late to mid-1990's and through-out the early twenty-first century the game industry has had incredible growth, both in profits as well as game console and/or computer system capabilities. The personal computer was responsible for some of this growth in gaming, but because the personal computer was designed for a broad set of intended uses, the personal computer hardware soon lagged behind the special purpose hardware of the dedicated gaming systems. Gaming consoles such as Microsoft's X-Box® and Sony's Playstation® provide the basis for game software to deliver realistic content. These platforms often include specialized hardware acceleration of typical mathematical and graphics functions that are often required by gaming software to provide realistic action and video.

Computer video games typically require input devices such as a controller to interact with the game. A game controller can be any input device used to control the video game, such as a keyboard or mouse, the more advanced games and gaming systems and consoles usually employ a gamepad, joystick, paddle, gesture detection devices, or any other specialized device designed for gaming, which receives physical input from the game player in control of said device. A game controller is typically used to govern the movement or actions of a player character (an avatar) within the video or computer game. This is most common in “Challenge-Type” games wherein the game is an obstacle course. In such, the game player controls the movements and actions of a player in a scenario, wherein the game controller, for example, permits the game player to choose and fire different weapons from a selection made available to the player by manipulating various buttons and switches on the controller. The player moves their character through a scene, firing the selected weapon against an enemy (typically a non-player character or an “NPC”) who is pitted against the game player as an adversary. The desired result (i.e., the “fun” of the game) is, for example, for the game player to traverse the obstacle course with his player character within the video game and arrive at an end point of safety, all the while using his skill in marksmanship and physical agility, albeit in a virtual world, to kill, wound or otherwise disable the enemy without the player's avatar getting seriously wounded or killed.

In Challenge-Type games, dialog, which permits some level of interaction or control between encountered characters, is almost non-existent as the purpose of the game (the “fun” or “interest” that is realized by the game player) is not to interact with others through narration, but instead is the thrill of killing or disabling your opponent before the opponent kills you.

“Narrative-Type” games typically have different intent, wherein the fun or interest for the game player is in the unfolding story and the drama component of the game. This is not to say that virtual physical encounters will not occur in Narrative-Type games, in that, some Narrative-Type games require the game player to incapacitate, injure or kill other characters that are encountered. It is just that the narrative portion and the drama component that surrounds a character encounter are more heavily weighted in the programming of the game. Since the game developer is trying to appeal to a different type of game player, game interaction and “aesthetics” of the game become more significant.

In video games, the player is often referred to as a “first person shooter,” in that, the person playing the video game by traversing the virtual world, often is the person who is shooting, casting spells, or any other form of performing damage on/to the various opponents or objects, as those opponents or objects are encountered. For example, the first person shooter has a firearm, a way of aiming the firearm, and a trigger. When the object is within the player's aim, operation of the trigger initiates firing upon the object so that the first person shooter is able to aim and fire at the various opponents and/or objects as they appear in the game's virtual world. To add skill and entertainment, the video games include a level of randomness to the action of firing upon an object. In that, each time the player fires upon the object, a certain amount of damage is recorded against that object, thereby requiring possibly several hits to significantly effect that object (e.g. annihilate, kill, freeze, vaporize, set afire . . . ). In some video games, a random percentage of the hits will result in noticeably greater damage. For example, randomly, one out of 20 hits (5%) will result in noticeably greater damage such as killing the enemy, freezing the object, immobilizing the object, destroying a vehicle or building, etc. In some video games, the probability of a hit causing this noticeably greater damage is increased by the player accumulating certain objects like a new sword or bigger gun and thereby may increase to, for example, randomly from one out of twenty (5%) to two out of thirty hits (6.67%), etc.

In video gaming of the prior art, there is no way for the player to make sure that a hit will result in such severe damage to the opposing object, and often, the player must shoot at the object several times to assure annihilation. There are times within a gaming scenario in which a player wants to assure that the opponent will be annihilated with one firing or one spell, etc.

What is needed is a gaming system that provides an interface that permits the player to engage a target and be assured that the target will receive maximum effect from the action.

### SUMMARY

In a gaming system, a player is presented with multiple targets and, upon invoking an action (e.g. operating a trigger, making a hand gesture, etc.), the gaming system determines which target from the multiple targets is the object of the action and the gaming system effects the intended target (e.g. fires a bullet at the object, casts a spell on the object, vaporizes the object, etc.). The amount of effect on the object of the action is algorithmically determined based upon, for example, distance (within the game space) from the player, angle with respect to the player, a holding of an object by the player (e.g. an accumulated weapon or spell), prior hits upon the object (e.g., a health level of the object), etc. If the player wants to assure that the effect of the action will be greater (e.g. annihilation of the object, freezing or immobilizing of the object), the player has an option to invoke the action in a special way so as to assure such damage. In one embodiment, the player holds the trigger for an extended period of time to invoke “critical hits” and, upon release of the trigger, the object of the action will incur greater damage (e.g. annihilation, freezing). Of course, without repercussions, there is no disincentive to the player for invoking critical hits. Therefore, in some embodiments, the player becomes more vulnerable to opponents, possibly frozen in position, during a period of time that, for example, the trigger is held (e.g. 1.2 seconds), providing a disincentive from using “critical hits” every time the player invokes an action.

In one embodiment, a method for inflicting critical hits in a video game operated in a virtual game space with a virtual viewport defining a local of a player of the video game is disclosed. An invocation of a trigger is detected and if the trigger is a critical hits trigger, dire consequences are invoked (set fourth) for the targeted game object. Conversely, if the trigger is not a critical hits trigger, standard consequences are invoked (set fourth) for the targeted game object.

In another embodiment, a method for inflicting critical hits in a video game operated in a virtual game space with a virtual viewport defining a local of a player of the video game is disclosed. A targeted game object from the at least two game objects is determined (e.g. aimed at) and an invocation of a trigger is detected. If the trigger remains for a period of time (e.g. is held), the trigger is a critical hits trigger and dire consequences are invoked upon the targeted game object. If the trigger does not remain for the period of time, standard consequences are invoked against the targeted game object.

In another embodiment, a computer-readable storage medium having embodied thereon a video game program operated in a virtual game space with a virtual viewport defining a local of a player of the video game is disclosed. At least a portion of the virtual viewport is displayed on a display device and the video game program is executable by a computing device for performing steps of including a) providing at least two game characters within the virtual game space, determining a targeted game object from the at least two game objects. Invocation of a trigger is detected and if the trigger is a critical hits trigger, dire consequences are invoked for the targeted game object. If the trigger is not a critical hits trigger, standard consequences for the targeted game object which, in some cases, includes such dire consequences.

In another embodiment, a gaming system is disclosed including a computer that has a display, a trigger (e.g. a gesture or button on a controller), and a storage. A virtual game space is defined within the storage and a plurality of game characters are defined within the storage at game character locations within the virtual game space. A viewport that is a subset of the virtual game space is defined within the storage at a location within the virtual game space. Software instructions that are stored within the storage are executed by the computer to inflict dire consequences upon a target object from the plurality of game objects by detecting activation of a critical hits trigger, and, responsive to activation of the critical hits trigger, inflicting the dire consequences on the target object.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of an exemplary game scenario with critical hits.

FIG. 2 illustrates a second perspective view of an exemplary game scenario with critical hits.

FIG. 3 illustrates a third perspective view of an exemplary game scenario with critical hits.

FIG. 4 illustrates a fourth perspective view of an exemplary game scenario with critical hits.

FIG. 5 illustrates a schematic view of an exemplary gaming system architecture.

FIG. 6 illustrates a schematic view of an exemplary gaming system virtual layout and viewport.

FIG. 7 illustrates a second schematic view of an exemplary gaming system virtual viewport.

FIG. 8 illustrates a schematic view of an exemplary gaming system data relationship.

FIG. 9 illustrates a first flow chart of an exemplary gaming system with critical hits.

FIG. 10 illustrates a second flow chart of an exemplary gaming system with critical hits.

FIG. 11 illustrates a third flow chart of an exemplary gaming system with critical hits.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In the following, the player is a person who is operating the game, typically the first person, perhaps in a first person shooter type of game. Throughout, the term “target” refers to a virtual object that is generally opposed to the player, e.g. an opponent or adversary. Targets are typically avatars of an enemy being, though targets are also known to be inanimate objects such as buildings, vehicles, aircraft, storage tanks, etc. Throughout, the term “projectile” represents any virtual object that is used as a weapon against a target, including, but not limited to, bullets, spells, rocks, fire, missiles, rockets, etc.

Typically, the player operates some type of controller (e.g. a keyboard, hand-held controller, joystick, etc.) while viewing the action, scenery, and characters of the game on a display. During the game, the player virtually traverses a virtual game space that is, typically, laid out as a virtual world having scenery and, at some locations within the virtual world, characters, of which in some embodiments, some are friendly and some are unfriendly. Throughout this description, even though a real person is the player, reference to “the player” is synonymous to reference to the player's virtual self within the virtual game space. Therefore, a distance between the player and one of the characters is a distance between the player's virtual self and the character within the virtual game space, not a distance between the player (human) and the character within the virtual game space.

The player is presented with a subset of the virtual game space, typically on a monitor or any known display device. In such, the player is able to see a certain distance into the virtual game space, both side-to-side and forward. This area within the virtual game space in which the player can see is referred to as the virtual viewport.

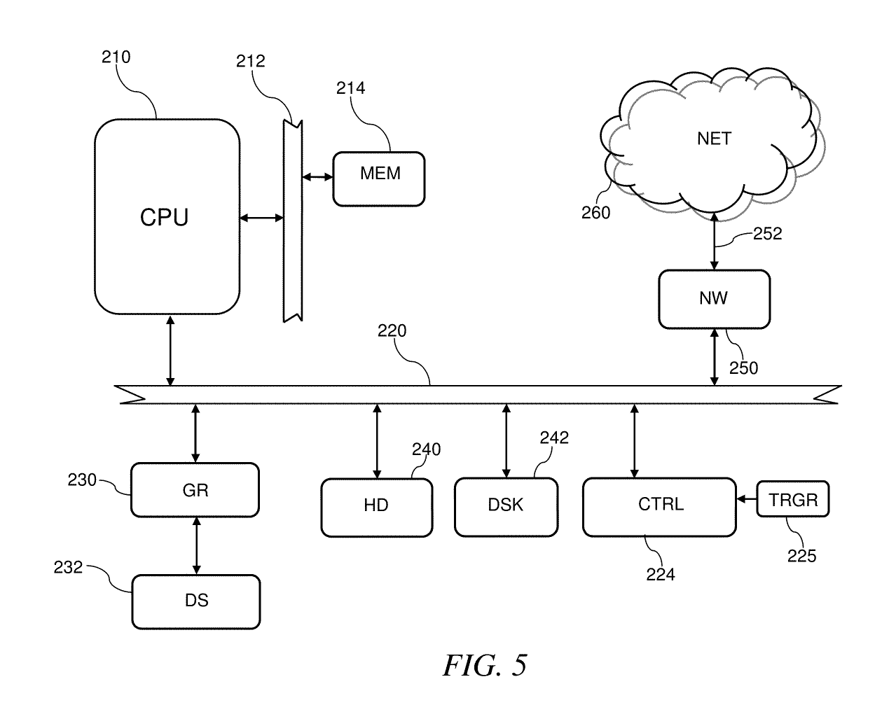

In many such games, the player must act upon other players, beings, and objects to achieve a goal, the goal being accumulating points, accumulating objects, advancing to higher levels, completing the game, etc. In many such games, the actions are an aggression against another player, being, or object such as shooting, stabbing, blowing up, freezing, casting a spell, etc. Typically, there is some form of aiming and some form of trigger 225 (see FIG. 5) to invoke this action. Aiming is performed by, for example, moving a reticule (e.g. crosshair) over the target with keyboard keys, a joystick, etc., though any form of aiming is anticipated. Once the reticule is where desired, a trigger 225 is activated by, for example, pressing a key on a keyboard of controller, and the action against the object at or near the reticule occurs. For example, if the weapon is a gun, an avatar of a bullet is displayed traveling from the gun to the object and, if the bullet hits the object, something typically is displayed, such as the object bleeding, breaking, falling, etc. In many games, the amount of effect upon the object depends upon the weapon being used (e.g. gun, bazooka, missile, spell, sword), the health of the object (e.g. was hit recently and is already bleeding), the type of object (e.g. a frail being or a strong giant), and often a probability (e.g. a hit on an object with a bullet has a 5% probability of killing that object).

Throughout this description, the term “invoking an action” refers to any operation performed by the user to invoke an action against an object within the game such as an opponent or an inanimate object such as a building, etc. Such invoking is, for example but not limited to, operating a trigger, making certain hand gestures, making a facial expression, etc. The action is, for example, firing of a weapon, casting a spell, stabbing, hitting, throwing something, etc. The desired result of the action is typically referred to as annihilation of the object, though depending upon the action being invoked and the object, the result is not necessarily annihilation, for example, freezing of the object, setting the object on fire, immobilizing the object, etc. Furthermore, when “critical hits” is not used, instead of annihilation, a lesser result often occurs such as wounding of the object. Therefore, in the following, any action is anticipated yielding any known result and, for brevity, the following will generally use a trigger and firing as the action and annihilation as the desired result for brevity reasons.

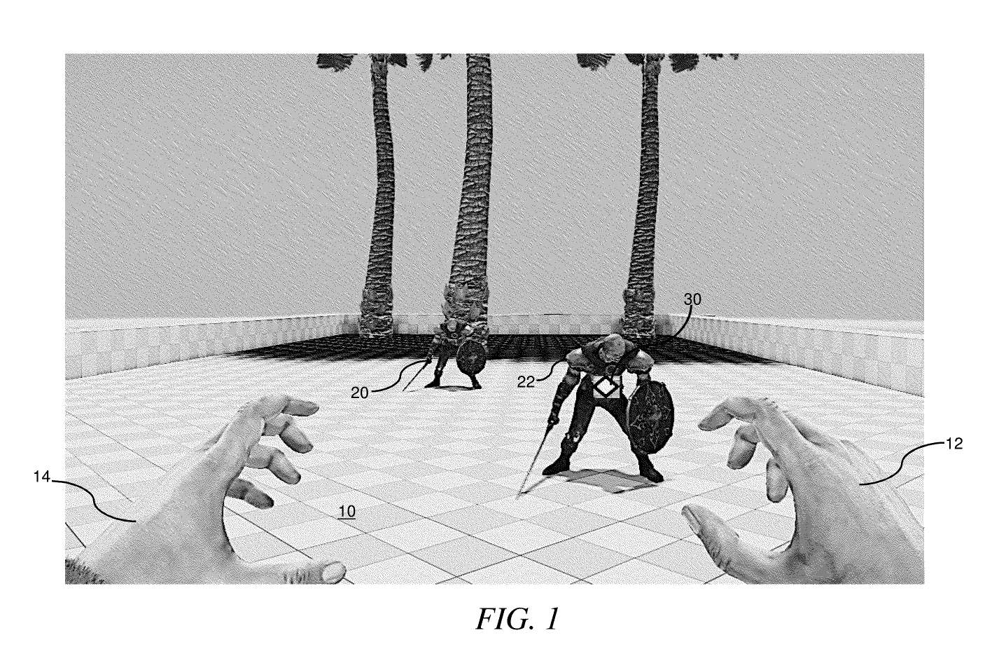

Referring to FIGS. 1 through 4, perspective views of typical game scenario are shown. In a first person shooter game, the player must aim at an intended target 20/22 (or use smart targeting), then invoke a trigger 225 to attempt to inflict harm on the intended target 20/22 by, for example, shooting a weapon at the target 20/22, throwing something at the target 20/22, casting a spell on the target 20/22, etc. Typically, the player has positioning controls such as a joystick, left/right/up/down buttons on a game controller, or keyboard controls to effect location controls, often panning to the left or right. In FIG. 1, an icon-reticule 30 indicates the player's focus (target) and is, in general, where the weapon (e.g., spell, bullet, grenade, etc.) will be targeted. In FIG. 1, the weapon is currently targeted at the closest adversary 22 of the two visible adversary elements 20/22 in the field 10 of the game (visual depiction of player's viewport). Two hands 12/14 are shown representing hands of the player for throwing objects or casting spells in the game, although any other depiction such as guns, crossbows, arrows, cannons, howitzers, turrets, etc., are anticipated.

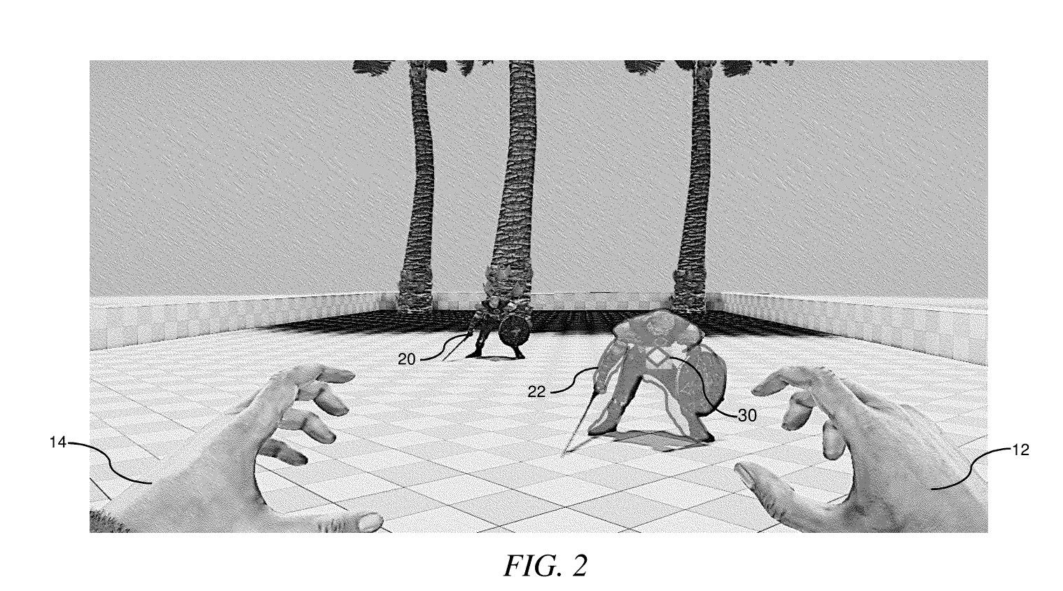

Once the target 20/22 is acquired (e.g. positioned at the icon-reticule 30), invoking the trigger 225 function initiates shooting, throwing, or casting a spell at that intended target 22, but even if aimed perfectly, there is no guarantee of destruction of the intended target 22. The degree of destruction is often modified based upon projectile velocity (e.g. speed of a bullet or an arrow), virtual distance from the intended target 22, direction and speed of movement of the intended target 22, simulated wind, health of the intended target 22, a certain possession of the player, etc. Such firing often includes a visual depiction of an object (bullet, arrow, fireball, etc.) moving towards the intended target 22 (not shown), then some change to the intended target 22 (see FIGS. 2 through 4) to indicate a hit by the object (e.g., for a fire ball, the intended target 22 is engulfed in flames; for a spell, the intended target 22 changes color and clarity; for a bullet, the intended target 22 bleeds, etc.) and a result of the hit, the intended target 22 goes down, the intended target 22 burns, the intended target 22 freezes, etc.

In many existing game systems, there is a probability of destruction for each hit on a given intended target 22. For example, in one game system, there may be a probability of 5% that a single hit will annihilate an intended target 22. If the intended target 22 is not annihilated, often the health of the intended target 22 is reduced so that a subsequent hit will have a greater probability of annihilation. Also, in some game systems, a certain possession of the player such as a certain magic spell, a more powerful weapon, a game object, etc., will increase the probability that a single hit will annihilate an intended target 22.

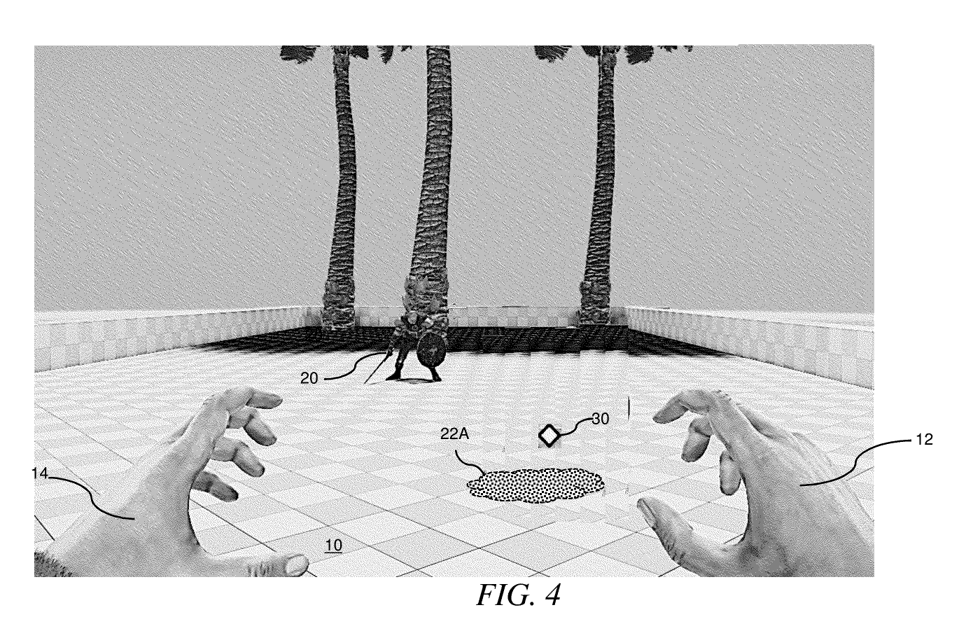

In FIG. 2, the player has fired a shot (or cast a spell) and the avatar of the intended target 22 has been changed to show some effect of the action. This is typically invoked by pressing and releasing a trigger 225. As an example in this scenario, the avatar of the intended target 22 is faded or blurred to indicate that the intended target 22 is wounded or frozen. Many other effects are anticipated including, but not limited to, making the intended target 22 look frozen, making the intended target 22 appear to be on fire, showing blood on the intended target 22, removing a piece of the intended target 22, discoloration of the intended target 22, audio effects, etc. In some embodiments, after a period of time (without being hit), the health of the intended target 22 returns and the avatar of the intended target 22 returns to normal (as in FIG. 1). By firing upon the intended target one or more additional times, at some point, the intended target 22 is annihilated or destroyed and the avatar of the intended target 22 changes to indicate that the intended target 22 is no longer active such as a pile of rubble 22A as shown in FIG. 4. Many other depictions of an annihilated intended target 22 are anticipated including, but not limited to, lying down of the intended target 22, vaporization of the intended target 22, crumbling of the intended target 22, etc.

As discussed, there is typically a probability that a single hit will have dire consequences on the object (e.g. annihilate, freeze, incapacitate . . . ) the intended target 22 (e.g. move directly from the intended target 22 FIG. 1 to the pile of rubble 22A FIG. 4), often requiring two or more actions (shots, spells, etc.) to achieve such consequences.

In situations in which the player needs to assure dire consequences against an object, a new feature is added to the game system called critical hits. In this, the player exchanges time for the assurance of consequences against the intended target 22. During this time that the player forfeits, the player has one or more disadvantages. For example, but not limiting, the player's movement is slowed or stopped, an enemy 20/22 becomes more aggressive, a single hit by an enemy 20/22 will destroy the player, the enemy 20/22 moves closer, etc.

In some embodiments, the amount of time required to invoke critical hits is fixed (e.g. 1.2 seconds). In some embodiments, the amount of time is reducible by gathering a possession by the player (e.g., having a gold ring reduces the time to 0.8 seconds). In some embodiments, the amount of time changes depending upon a stage of the game. In some embodiments, the amount of time increases each time “critical hits” is used. In some embodiments, the amount of time is different for each possible weapon used by the player. It is fully anticipated that other parameters will change this amount of time and such are included here within.

There are many mechanisms anticipated to invoke critical hits. For example, but not limited to, use of an auxiliary trigger 225 (e.g. a different key on the keyboard), holding of the trigger 225 for the required amount of time, holding of a controller button while also holding the trigger 225, specific hand/arm gestures or body postures such as holding hands clenched as fists, etc. For example, if the game progresses to a point as shown in FIG. 1 and the player wants to assure dire consequences are effected upon the intended target 22 (e.g., the intended target 22 is annihilated), the player presses and holds the trigger 225 for 1.2 seconds, after which upon release of the trigger 225, the intended target 22 is annihilated and the next game scene is that shown in FIG. 4. During the time that the player holds the trigger 225, as discussed above, other enemy objects (e.g. object 20) are still moving and have the ability to attack the player, etc.

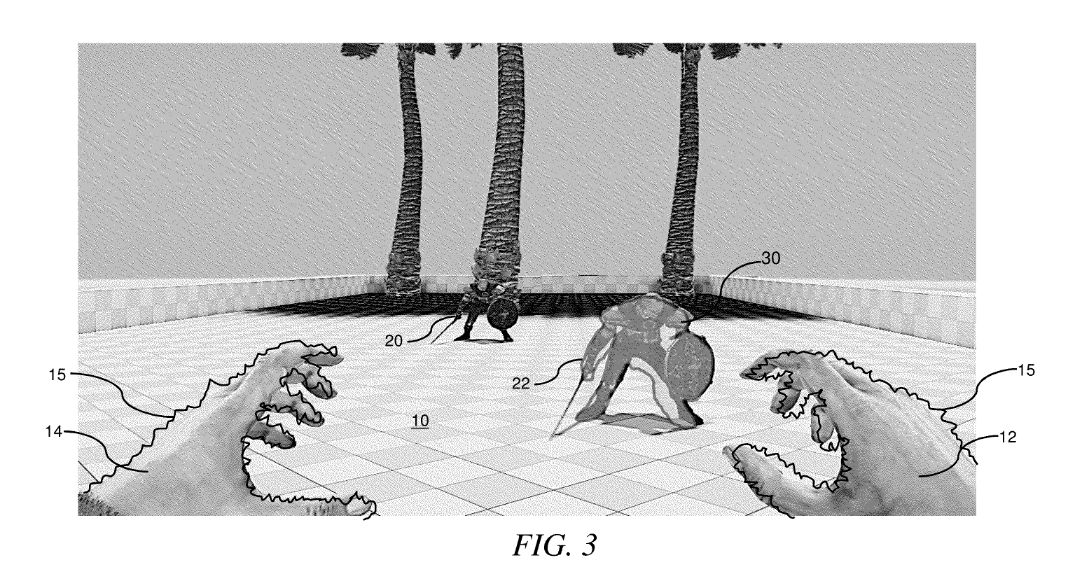

In some embodiments, during the time that the player in invoking critical hits (e.g. while the trigger 225 is being held), a visual and/or audio indication 15 is displayed as shown in FIG. 3 as vibration of the player's virtual hands 14/16, though many other indications are anticipated including, but not limited to, certain game sounds, changes in color, changes in shape, etc.

Referring to FIG. 5, a schematic view of an exemplary computer-based gaming system architecture is shown. The exemplary computer-based gaming system represents one such typical computer system used for gaming, many other systems and architectures are anticipated. The example computer-based gaming system is shown in its simplest form, having a single processor 210. Many different computer-based gaming architectures are known that accomplish similar results in a similar fashion and the present invention is not limited in any way to any particular computer-based gaming system. The present invention works well utilizing a single processor 210 system as shown in FIG. 5, a multiple processor system where multiple processors share resources such as memory and storage, an array of cell processors, etc. In the example of a computer-based gaming system shown, the processor 210 executes or runs stored programs that are generally stored for execution within a memory 214. The processor 210 is any processor or a group of processors, for example an Intel Pentium-4® CPU or the like. The memory 214 is typically connected to the processor by a memory bus 212 and is any memory 214 suitable for connection with the selected processor 210, such as SRAM, DRAM, SDRAM, RDRAM, DDR, DDR-2, etc. Also connected to the processor 210 is a system bus 220 for connecting to peripheral subsystems such as a network interface 250, storage 240, a disk drive (e.g. DVD, CD) 242, a graphics adapter 230 and one or more keyboards or game controllers 224. In some embodiments, the keyboard or game controller 224 has a trigger 225 that, when operated, initiates the step of firing upon a target 20/22. The graphics adapter 230 receives commands and display information from the system bus 220 and generates a display image that is displayed on the display device 232. In some embodiments, to improve graphics performance, the graphics adapter has direct access to the memory 214 or has access to the memory bus 212 as known in the industry.

In general, the storage device 240 (e.g. hard disk, flash memory, etc.) is used to store programs, executable code and data persistently, while the disk drive 242 is used to load CD/DVD/Blu-ray disks having programs, executable code and/or data. These peripherals are examples of input/output devices, persistent storage and removable media storage. Other examples of persistent storage include core memory, FRAM, flash memory, etc. Other examples of removable media storage include CDRW, DVD, DVD writeable, Blu-ray, compact flash, other removable flash media, floppy disk, etc. In some embodiments, other devices are connected to the system through the system bus 230 or with other input-output connections/arrangements as known in the industry. Examples of these devices include printers; graphics tablets; joysticks; and communications adapters such as modems and Ethernet adapters.

In some embodiments, a network interface 250 connects the computer-based system to a network 260 (e.g. the Internet) through a link 252 which is, preferably, a high speed link such as a cable broadband connection, a Digital Subscriber Loop (DSL) broadband connection, a T1 line or a T3 line. In such, the network interface 250 is used to share portions of an operating game with other players, share data, share virtual game space, tokens, game pieces, game monetary instruments, high score data, download game programs, segments, updates, and many other uses. In some embodiments, the link 252 is a wireless link 252.

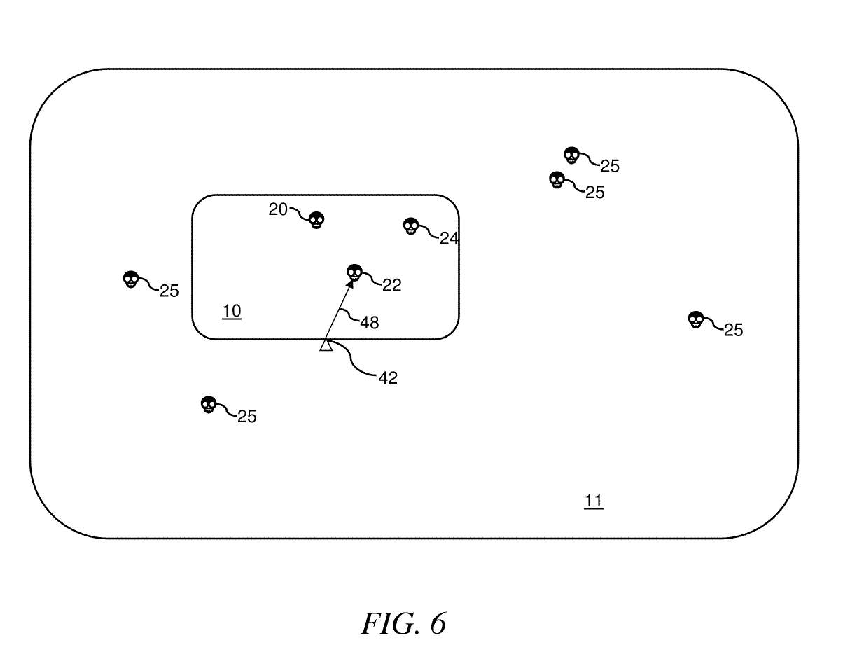

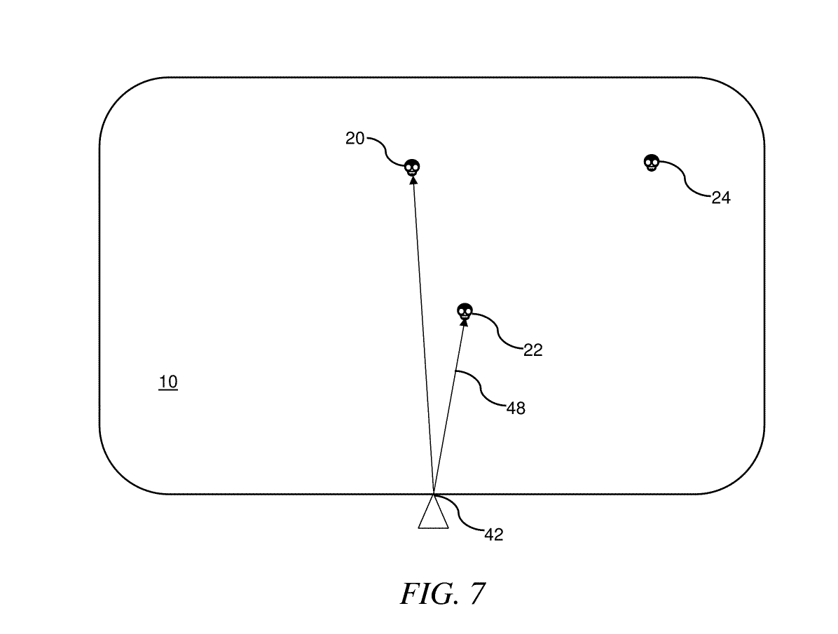

Referring to FIGS. 6 and 7, schematic views of an exemplary gaming system virtual game space 11 and viewport 10 are shown. The gaming virtual game space 11 shown in FIG. 5 is greatly simplified over any virtual layout used in an anticipated game for reasons of brevity and clarity. This exemplary gaming virtual game space 11 is shown only in two dimensions (X and Y) while it is understood that many modern gaming systems operate in three dimensions (X, Y, and Z). Also, the exemplary gaming virtual game space 11 shows the player's viewport 10 and an assortment of targets (opponents) 20/22/24/25. Some of the targets 20/22/24 are within the player's viewport 10 and other targets 25 are outside of the player's viewport 10 (e.g. not within view of the player on the display 232).

In general, the player perceives themselves at a particular location 42 within the viewport 10, looking out into the virtual space 11 seeing only what is visible with the viewport 10. The player takes aim at one target 22 and invokes a trigger 225 by, for example, pressing a trigger feature 225 on a controller 224 (e.g. button, touch screen location, etc.), by making a gesture in systems with body language detection, etc.

To invoke a critical hit, the player performs a predefined task such as holding the trigger 225 for an amount of time, pressing a secondary trigger button while/before pressing the trigger 225, pressing an alternate trigger, making a specific hand gesture, etc. In some embodiments, the game indicates that the critical hit is being invoked by changing the appearance of the player's weapon (e.g. hands throw differently than without critical hits, spells flare, a projectile looks different, hands appear to vibrate as in FIG. 3, etc.). If the player prematurely aborts an attempt at making a critical hit (e.g. releases the trigger before the required amount of time lapses), a normal hit is made. In some embodiments, an indication that a critical hit has been invoked is made by a change to the target 22 and/or a sound that is different than the typical firing or throwing sound.

Invocation of a critical hit typically results in some visual indication 48 of an action upon the target 22. For example, a bullet travels 48 from the player's location 42 to the target 22. In other examples, various realistic or imaginary object images are uses such as fireballs, cannon balls, arrows, rocks, missiles, rockets, flares, flames, magic spells, etc. As a result of a hit, the target 22 typically changes in some way to provide feedback to the player as shown in FIGS. 2, 3 and 4. In some embodiments, the target 22 moves (e.g. is pushed back in the viewport 10), the target 22 blurs, the target 22 breaks, the target 22 crumbles, the target 22 vibrates, the target 22 bleeds, part of the target 22 falls off, the target 22 catches fire, the target 22 freezes, etc. This is an exemplary list and is not meant to be exhaustive. If the hit invokes dire consequences (e.g. annihilates) against the target 22, the target 22 changes to an image that indicates such, for example, a the target 22 that is a being or creature rests horizontally instead of vertically, or is reduced to a pile of debris 22A, falls to the ground, etc. As an example of such for an inanimate object such as a vehicle or building, that object blows up, catches fire, crumbles, etc. This is not an exhaustive list and any visual way of indicating dire consequences is anticipated.

Normally, each time the player aims at a target 22 and invokes the trigger feature, an algorithm determines whether the action is effects dire consequences upon the target 22. In some embodiments, this determination is random (e.g. each time the target 22 is hit, there is a 5% probability of dire consequences or annihilation). In some embodiments, certain possessions affect the outcome or probability of such (e.g., each time the target 22 is hit, there is a 5% probability of dire consequences; unless the player has a golden arrow, then there is a 15% probability of dire consequences). In some embodiments, the health of the target 22 plays a role in this determination such that, if dire consequences do not occur, the health of the target 22 is decreased by some percentage so that subsequent hits result in a greater probability of dire consequences. There are many ways to determine the severity of an action or hit, all of which are included here within.

In the described gaming system, the player has the ability to invoke a critical hit. By invoking a critical hit, the above calculations are ignored or substantially ignored and the player is assured of dire consequences or reasonably assured of dire consequences. In such, when the player invokes a critical hit, instead of, for example, a 5% probability of dire consequences, there is a 100% probability of dire consequences (assured), or in some embodiments a 99% probability or 95% probability of dire consequences (reasonably assured).

Of course, without any personal risk, a typical player would always invoke critical hits to assure dire consequences of every the target 22 encountered. To provide such personal risk, in a preferred embodiment, the player will have at least one consequence while they invoke critical hits. For example, in some embodiments, the player invokes a critical hit by holding the trigger feature for a certain period of time, for example 1.2 seconds. After this period, the firing and dire consequences occur, but during this period of time, the player may be vulnerable to the target 22 or other targets 20/22/24/25 (enemies) attacking, the player may slow or stop moving, the player may lose some abilities, etc.

In some embodiments, the player must accumulate or possess certain objects before they can invoke a critical hit. In some embodiments, the player has a limited number of times that they can invoke a critical hit. In some embodiments, critical hits are only enabled during certain segments of the game or in certain locations within the virtual game space.

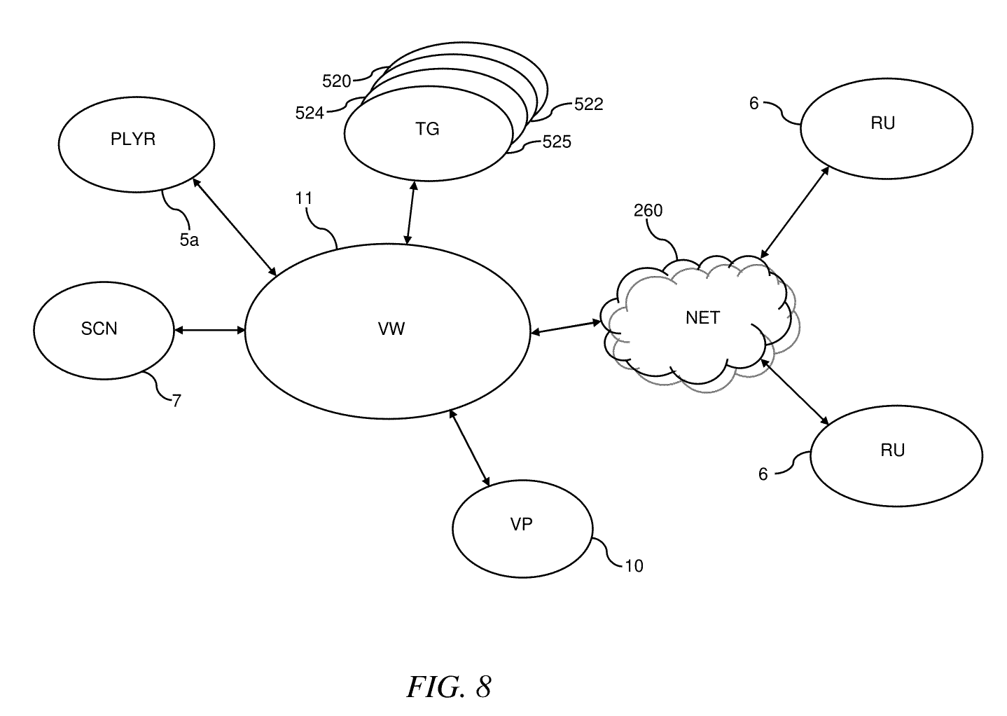

Referring to FIG. 8, a schematic view of an exemplary gaming system data relationship is shown. Again, this is a simplified example of one particular data relationship and many other data relationships are anticipated. In modern gaming, a virtual game space 11 is typically defined as the space in which a player and other objects can roam. As the player roams through the virtual game space 11, the player is presented with a visual representation of a portion of the virtual game space 11 on, for example, the display device 232. That portion of the virtual game space 11 is the player's viewport 10.

Representations in the virtual game space 11 have units of measurement that are defined by the gaming system that may or may not relate to real objects. For example, in one model, a width of a doorway is 350 distance units which does not necessarily relate to an actual width of any real doorway. Of course, virtual objects that must pass through this doorway need be less than 350 distance units wide, etc.

In the exemplary relationship of FIG. 8, the virtual game space 11 is a data structure that includes elements related to the size (e.g. rectangular area for a 2-dimensional model) of the virtual world. In this example, the total width (X) and depth (Y) when looking at the virtual gaming space from above is stored in this data structure for the virtual game space 11.

The virtual viewport 10 is a data structure that includes elements related to the size and location of the virtual viewport 10 within the virtual game space 11. As the player traverses the virtual world—(e.g. by invoking movement controls on the control device 224), the coordinates (X, Y) of the virtual viewport 10 are updated and any objects visible within the virtual viewport 10 are presented on, for example, the display device 232.

The player element 5a (single player is shown for simplicity) is a data structure that includes elements related to the player such as current location within the virtual game space 11, current strength, direction of movement, direction of view within the virtual world, current weapons, current ammunition, maximum speed, etc. In the examples shown, the player's location within the virtual world is the same as the coordinate of the virtual viewport 10.

To make games realistic and interesting, complex scenery is often included having buildings, landscape, hills, mountains, rocks, streams, oceans, animate objects, animals, etc. For simplicity, the list of such objects and interaction of such objects with the player and targets 20/22/24/25 are not described (e.g., the targets 20/22/24/25 are able to hide behind a building). Such scenery and background is represented by scenery data 7 and not fully described here within for brevity and clarity reasons.

For each enemy or target 20/22/24/25, a target data structure 520/522/524/525 includes, for example, coordinates of the associated target 20/22/24/25, identification of the associated target 20/22/24/25, direction and speed of movement of the associated target 20/22/24/25, strength of the associated target 20/22/24/25, etc. Note, only four target data structure 520/522/524/525 are shown for simplicity, though any number of target data structures 520/522/524/525 is anticipated.

In some embodiments, the gaming system is connected to one or more remote gaming systems 6 through, for example, a computer network 260. In such embodiments, it is anticipated that multiple remote players 6 exist, each having data structure elements representing that remote player's avatar (e.g., coordinates, virtual viewport, strength, etc.). The complexities of such are not described for clarity and brevity reasons.

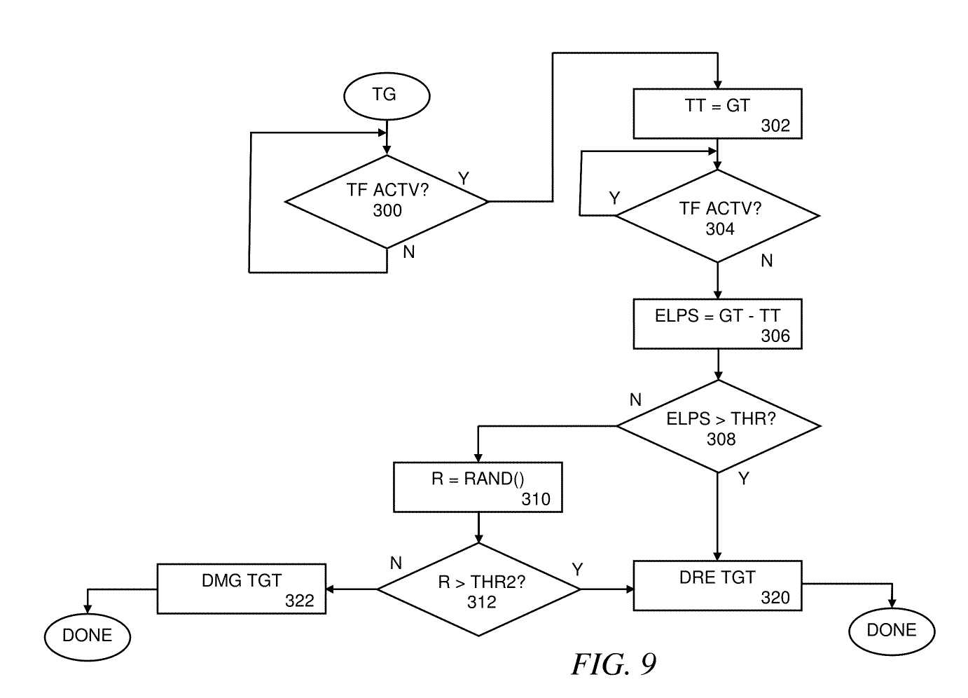

Referring to FIG. 9, a first flow chart of an exemplary gaming system with critical hits is shown. Again, note that this is an exemplary program flow and there are many other program flows anticipated that will achieve similar results in similar or different manners.

Although many concurrent activities often occur in tandem such as scenery movement, target movement, viewport movement, etc., for simplicity, the trigger operation alone is shown and described. In this, it is assumed that the intended target 22 is currently being aimed at (e.g. beneath the player's reticule 30).

Although shown as a loop, the described flow is easily adapted to an interrupt-based system as known to those skilled in the art. To start, a closed loop 300 is run to see if the trigger function is active. If the trigger function is not active 300 (e.g. the trigger button 225 has not been pressed), the loop continues. If the trigger function is active 300 (e.g. the trigger button 225 has been pressed), a temporary time is set 302 to the current game time. Ignoring a need to de-bounce the trigger contacts if a mechanical switch is used, another loop 304 is started, looping upon itself as long as the trigger function is active (e.g., the trigger button 225 is held). Now, if the trigger function is inactive 304 (e.g., the trigger button 225 has been released), an elapsed time is calculated 306 by subtracting the game time from the temporary time stored above. If the elapsed time is greater than a threshold 308, then critical hits is invoked and the intended target 22 receives dire consequences 320 (e.g. projectile visually traverses towards the intended target 22, the intended target 22 form changes to indicate annihilation and the intended target 22 is removed from the virtual game space). In this, the invocation of a critical hit is predicated on holding the trigger function for a period of time, the threshold. For example, holding the trigger button 225 for 1.2 seconds invokes critical hits.

If the elapsed time is less than the threshold 308, then an ordinary hit is processed, in this example, a random number, R, is generated 310 (e.g. between 1 and 100) and if the random number is greater than a second threshold 312 (e.g. 95), then the intended target 22 receives dire consequences 320 as described above. If the random number is not greater than a second threshold 312 (e.g. 95), then the intended target 22 is damaged 322 (non-dire consequences) and remains viable. As previously described, there are many existing algorithms for determining the damage inflicted by a standard hit on an intended target 22, all of which are included here within. For example, in some algorithms, damage 322 reduces the intended target's health and if zero is reached, the intended target 22 is annihilated. As another example, in some embodiments, a possession of the player adjusts the hit to cause more or less damage 322 to the intended target 22.

Referring to FIG. 9, a second flow chart of an exemplary gaming system with critical hits is shown. Again, note that this is an exemplary program flow and there are many other program flows anticipated that will achieve similar results in similar or different manners.

Although many concurrent activities often occur in tandem such as scenery movement, target movement, viewport movement, etc., for simplicity, the trigger operation alone is shown and described. In this, it is assumed that the intended target 22 is currently being aimed at (e.g. beneath the player's reticule).

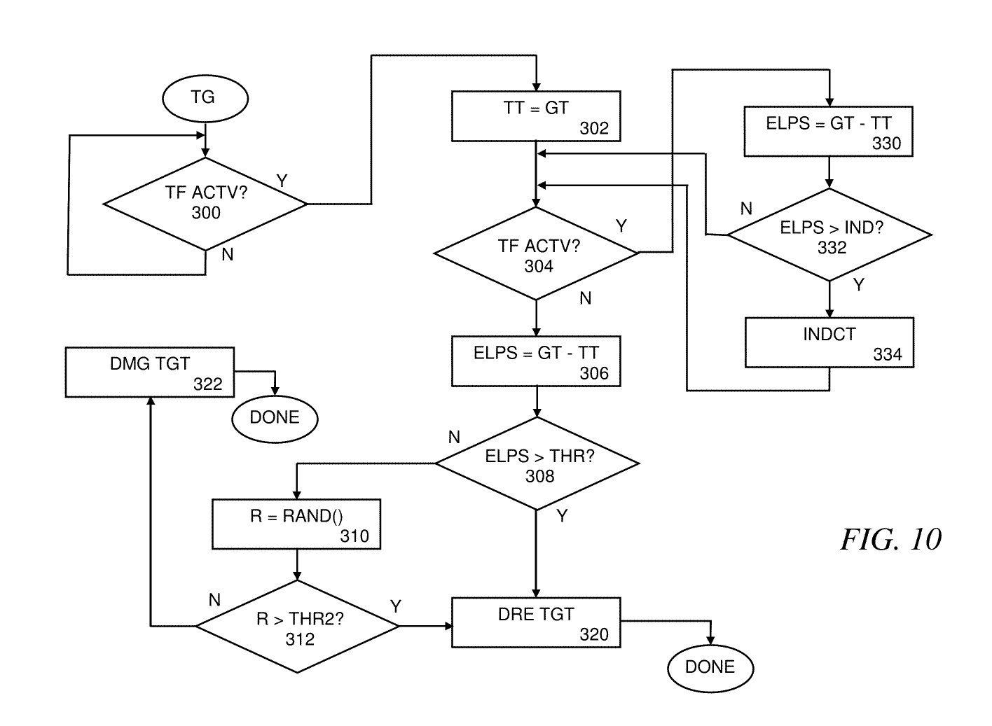

Although shown as a loop, the described flow is easily adapted to an interrupt-based system as known to those skilled in the art. The algorithm shown in FIG. 10 is similar to that in FIG. 9, except there is an indication to the player that they have invoked critical hits such as a change to the displayed image, a sound, a vibration 15, etc.

The algorithm begins with a closed loop that checks to see if the trigger function is active. If the trigger function is not active 300 (e.g. the trigger button 225 has not been pressed), the loop continues. If the trigger function is active 300 (e.g. the trigger button 225 has been pressed), a temporary time is set 302 to the current game time. Ignoring a need to de-bounce the trigger contacts if a mechanical switch is used, another loop is entered, looping for as long as the trigger function is active (e.g., as long as trigger 225 is held). If the trigger function is still active 304 (e.g., the trigger button 225 is still being held), an elapsed time is calculated 330 by subtracting the game time from the temporary time stored above. If the elapsed time is greater than an indicator threshold 332, then the player has held the trigger function for long enough (e.g. 0.25 seconds) and an indication is made 334 such as a sound, vibration, or change to the image displayed on the graphics display 232 (e.g., the image of the player's hands vibrate 15, a weapon changes color or shape, etc.). The loop continues until the trigger function becomes inactive 304.

When the trigger function becomes inactive 304 (e.g., the trigger button 225 has been released), an elapsed time is calculated 306 by subtracting the game time from the temporary time stored above. If the elapsed time is greater than a critical hits threshold 308, then critical hits is invoked and the intended target 22 receives dire consequences 320 (e.g. projectile visually traverses towards the intended target 22, the intended target 22 form changes to indicate annihilation and the intended target 22 is removed from the virtual game space). In this, the invocation of a critical hit is predicated on holding the trigger function for a period of time, the threshold. For example, holding the trigger button 225 for 1.2 seconds invokes critical hits.

In some embodiments, the indication threshold is the same value as the critical hits threshold, in which, the indication 334 will occur to inform the player that release of the trigger function will invoke a critical hit. In some embodiments, the indication threshold is less than the critical hits threshold, in which, the indication 334 will occur before critical hits is met to show the player that they are about to invoke critical hits. In some embodiments, multiple stages (or thresholds) are included (not shown for brevity reasons) so that there are stages of indication such as, vibration after 0.25 seconds, faster vibration after 0.75 seconds, hands 12/14 turning orange after 1 second, and hands 12/14 turning red after 1.2 seconds (indicating critical hits achieved).

If the elapsed time is less than the critical hits threshold 308, then an ordinary hit is processed, in this example, a random number, R, is generated 310 (e.g. between 1 and 100) and if the random number is greater than a dire threshold 312 (e.g. greater than 95), then the dire consequences are inflicted 320 upon the intended target 22 as described above. If the random number is not greater than a second threshold 312 (e.g. less than 95), then the intended target 22 is damaged 322. As previously described, there are many existing algorithms for determining the damage inflicted by a standard hit on an intended target 22, all of which are included here within. For example, in some algorithms, damage 322 reduces the intended target's health and if zero is reached, the intended target 22 receives dire consequences. As another example, in some embodiments, a possession of the player adjusts the hit to cause more or less damage 322 to the intended target 22.

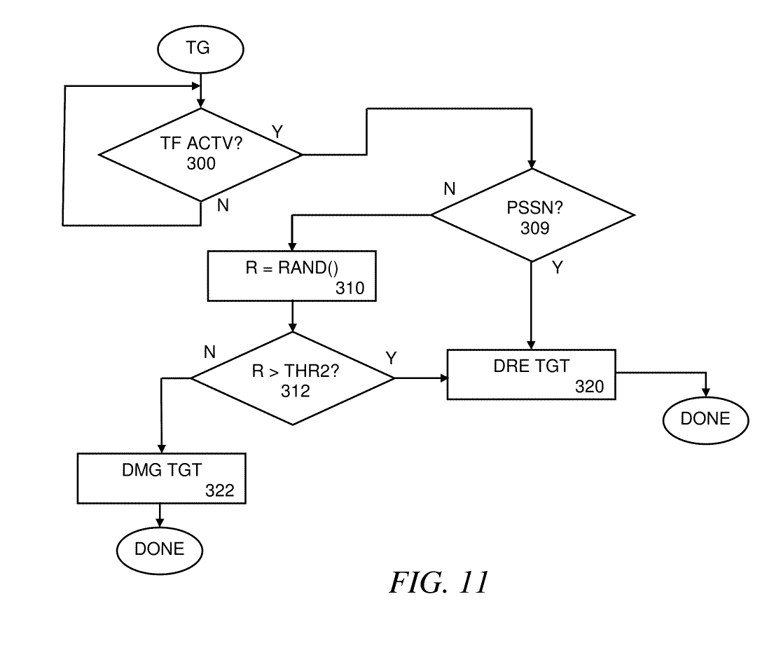

Referring to FIG. 11, a third flow chart of an exemplary gaming system with critical hits is shown. Again, note that this is an exemplary program flow and there are many other program flows anticipated that will achieve similar results in similar or different manners.

As discussed, although many concurrent activities often occur in tandem such as scenery movement, target movement, viewport movement, etc., for simplicity, the trigger operation alone is shown and described. In this, it is assumed that the intended target 22 is currently being aimed at (e.g. beneath the player's reticule).

Although shown as a loop, the described flow is easily adapted to an interrupt-based system as known to those skilled in the art. To start, a closed loop is run to see if the trigger function is active. If the trigger function is not active 300 (e.g. the trigger button 225 has not been pressed), the loop continues.

If the trigger function is active 300 (e.g. the trigger button 225 has been pressed), a test is performed 309 to determine if the player has a particular possession such as a certain magic spell, a game object (e.g. silver chalice), a reward previously given for achieving some level of success, etc. If the player has such a possession 309, then critical hits is invoked and the intended target 22 receives dire consequences 320 (e.g. projectile visually traverses towards the intended target 22, the intended target 22 form changes to indicate death and the intended target 22 is removed from the virtual game space). In this, the invocation of a critical hit is predicated on holding the trigger function for a period of time, the threshold. For example, activating the trigger while in possession of a certain magic spell invokes critical hits.

If the player does not have such a possession 309, then an ordinary hit is processed, in this example, a random number, R, is generated 310 (e.g. between 1 and 100) and if the random number is greater than a second threshold 312 (e.g. greater than 95), then the intended target 22 received dire consequences 320 as described above. If the random number is not greater than a second threshold 312 (e.g. less than or equal to 95), then the intended target 22 remains viable. As previously described, there are many existing algorithms for determining the damage inflicted by a standard hit on an intended target 22, all of which are included here within. For example, in some algorithms, damage 322 reduces the intended target's health and if zero is reached, the intended target 22 is annihilated. As another example, in some embodiments, a possession of the player adjusts the hit to cause more or less damage 322 to the intended target 22.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method for inflicting dire consequences upon an object in a video game operated in a virtual game space with a virtual viewport defining a local of a player of the video game, at least a portion of the virtual viewport displayed on a display device, the method comprising:
a) providing at least two game objects within the virtual game space;
b) providing a player virtual location within the virtual viewport;
c) displaying a depiction of at least a portion of the virtual viewport on the display device;
d) determining a targeted game object from the at least two game objects;
e) detecting an invocation of a trigger;
f) if the trigger is a critical hits trigger, invoking dire consequences for the targeted game object; and
g) if the trigger is not a critical hits trigger, invoking standard consequences for the targeted game object.

2. The method of claim 1, wherein the invocation of the trigger is pressing a trigger button.

3. The method of claim 2, wherein holding of the trigger for a predetermined time period is the critical hits trigger.

4. The method of claim 3, wherein after the holding of the trigger for a predetermined time period, displaying a visual indication of critical hits on the display device.

5. The method of claim 1, wherein the invocation of the trigger is a hit gesture.

6. The method of claim 5, wherein the critical hits trigger is a gesture different than the hit gesture.

7. The method of claim 1, wherein the dire consequences is annihilation of the targeted game object.

8. The method of claim 1, wherein the dire consequences is incapacitation of the targeted game object.

9. The method of claim 1, wherein the dire consequences is freezing of the targeted game object.

10. A method for inflicting dire consequences upon an object in a video game operated in a virtual game space with a virtual viewport defining a local of a player of the video game, at least a portion of the virtual viewport displayed on a display device, the method comprising:
a) providing at least two game characters within the virtual game space;
b) providing a player virtual location within the virtual viewport;
c) displaying a depiction of at least a portion of the virtual viewport on the display device;
d) determining a targeted game object from the at least two game objects;
e) detecting an invocation of a trigger;
f) if the trigger remains for a period of time, the trigger is a critical hits trigger and invoking dire consequences on the targeted game object; and
g) if the trigger does not remain for the period of time, invoking standard consequences against the targeted game object.

11. The method of claim 10, wherein the period of time is 1.2 seconds.

12. The method of claim 10, further comprising during the time period, displaying a visual indication of critical hits on the display device.

13. The method of claim 10, wherein the dire consequences is annihilation of the targeted game object.

14. The method of claim 10, wherein the dire consequences is incapacitation of the targeted game object.

15. The method of claim 10, wherein the dire consequences is freezing of the targeted game object.

16. A computer-readable storage medium having embodied thereon a video game program operated in a virtual game space with a virtual viewport defining a local of a player of the video game, at least a portion of the virtual viewport displayed on a display device, said video game program executable by a computing device for performing steps of a method for inflicting dire consequences upon an object in a said video game, the steps comprising:
a) providing at least two game objects within the virtual game space;
b) providing a player virtual location within the virtual viewport;
c) displaying a depiction of at least a portion of the virtual viewport on the display device;
d) determining a targeted game object from the at least two game objects;
e) detecting an invocation of a trigger;
f) if the trigger is a critical hits trigger, invoking dire consequences for the targeted game object; and
g) if the trigger is not a critical hits trigger, invoking standard consequences for the targeted game object.

17. The method of claim 16, wherein detecting an invocation of the trigger include determining if the trigger is held for a period of time.

18. The method of claim 17, wherein the period of time is 1.2 seconds.

19. A gaming system comprising:
a computer;
a display operatively coupled to the computer;
a trigger operatively coupled to the computer;
a storage operatively interfaced to the computer;
a virtual game space defined within the storage;
a plurality of game objects defined within the storage at game object locations within the virtual game space;
a viewport being a subset of the virtual game space defined within the storage at a location within the virtual game space; and
software instructions stored within the storage and executed by the computer, the software instructions operable to inflict dire consequences upon a target object from the plurality of game objects by detecting activation of a critical hits trigger, and, responsive to activation of the critical hits trigger, inflicting the dire consequences on the target object.

20. The gaming system of claim 19, wherein the software instructions operable to inflict dire consequences detect activation of a critical hits trigger by determining if a trigger is held for a period of time.

21. The gaming system of claim 19, wherein the dire consequences is annihilation of the targeted object.

22. The gaming system of claim 19, wherein the dire consequences is incapacitation of the targeted object.

23. The gaming system of claim 19, wherein the dire consequences is freezing of the targeted object.
